(19) United States
(12) Patent Application Publication
(10) Pub. No.: US 2005/0037112 A1
(43) Pub. Date: Feb. 17, 2005

(54) Edible straw and method for making the straw

(76) Inventors: Deborah Daley, Davie, FL (US); Carla Finney, Ocala, FL (US); Elena Bou, Tampa, FL (US)

Correspondence Address: DEBORAH DALEY, 13022 SW 40 STREET, DAVIE, FL, 33330, US

(21) Appl. No.: 10/735,231

(22) Filed: Dec. 12, 2003

Related U.S. Application Data
(60) Provisional application No. 60/494,846, filed on Aug. 13, 2003.

(51) Int. Cl. A23G 1/00

(52) U.S. Cl. 426/104

(57) ABSTRACT

A nutritious edible straw for imbibing liquids is made from a mixture of dry ingredients and wet ingredients that have been baked. The dry ingredients include flour, a sugar source, a fiber source, a leavening agent, and a flavoring agent. The wet ingredients include egg whites, sugar, and a flavoring agent. According to a method of making the edible straw, the dough can be made as a cylinder, pierced with a rod that remains intact, and released on completion of the baking process. Alternatively, the dough can be made by extruding the dough in a cylinder shape with a cavity formed as a result of the extrusion mold and, then, baked with or without a rod. In the case of utilizing the rod, the rod is released on completion of the baking process.

### CROSS-REFERENCE TO RELATED APPLICATION

This application claims the benefit under 35 U.S.C. § 119(e) of U.S. Provisional Application No. 60/494,846, filed Aug. 13, 2003, and entitled “EDIBLE STRAW AND METHOD FOR MAKING THE STRAW.”

### BACKGROUND OF THE INVENTION

1. Field of the Invention

The invention lies in the field of food products. This invention relates to an edible straw and method for making the straw. The straw is entirely edible, maintains its shape for an extended period of time, and provides nutritional benefits as a breakfast and/or snack food. The straw is primarily for children yet adults will enjoy the novelty as well. The straw contributes significant amounts of complex carbohydrates, protein, beneficial fats, fiber, phytonutrients, vitamins, and minerals to the consumer.

2. Description of the Related Art

It is well documented that obesity has become an epidemic in the United States as well as globally. Hunger and malnutrition is equally as concerning for the welfare of our future generations. The long-term health of children is being greatly jeopardized. One of the greatest challenges that exist is finding nutritious, yet delicious, food items for children. Studies are showing that children's eating habits are poor and that this is a significant factor leading to childhood obesity, impaired cognitive performance and increased long term risk of diabetes, heart disease, cancer, growth retardation, low resistance to disease, and long term impairment of childhood development. Satisfying dietary preferences, while trying to ensure healthy nutrition, is a true dilemma not only for children but for adults and caregivers as well. People often come to view nutritious foods as those foods that do not taste good. Due to society's need for convenience and meals on the go, sugary, salty, and high-fat snack sales are on the rise. In an attempt to address the unhealthy proportion of fats in the typical American diet, an array of reduced fat and fat free products were created. Unfortunately, most of these reduced-fat and fat-free food items are high in sugar and refined carbohydrates and substantially provide non-nutritious empty calories. Consumers purchase these products believing they are nutritious and, furthermore, tend to over consume, which exacerbates the obesity epidemic and distracts them from nutrient rich food choices.

The media, particularly television, is dominated with commercials promoting what amounts to “junk foods” laden with saturated and trans-fatty acids, highly refined sugars, processed white flours, and controversial ingredients such as artificial colors, flavors, and chemical preservatives. Preschool and kindergarten age children in the United States view over 9,000 food commercials during the typical year. There exist a growing number of products that attempt to combine one or two healthful benefits; yet these products are not novel enough in function, taste, and/or marketing to attract children.

All of these occurrences, coupled with the fact that children, as well as adults, tend to be fussy about their food likes and dislikes, leads to a void in the marketplace for nutritious and delicious convenience food products.

At the present state of development, nothing exists in the marketplace to impart a balanced nutritious breakfast/snack option that is in a tubular, straw-like shape, thereby functioning as a drinking straw. Refined sugar and flour-based wafer-type straw cookies exist but do not hold up in liquids for an extended length of time without a waterproof or, at least, a water-resistant, coating. Additionally, these products do not contribute significant amounts of complex carbohydrates, protein, beneficial fats, fiber, phytonutrients, vitamins, and minerals when consumed.

The prior art includes various edible food products that also have various functionalities.

Edible wafer and sugar cones for holding ice cream have existed for many years. Such containers are, generally, formed by pouring liquid waffle dough into a mold or forming a single sheet of dough into a cone shape. See, i.e., U.S. Pat. No. 5,626,897 to Goldstein et al. entitled “Uncooked Bread Dough around Mandrel to Form Cone.” These containers are suitable for holding solids and viscous liquids (i.e., ice cream and melted ice cream). In addition, prior-art cones are too porous to air to allow for the vacuums required to operate a straw. Furthermore, such containers cannot hold low viscosity liquids, such as milk, water, juice, and the like for any extended period of time. For example, cooked waffle dough without any water-resistant coating can hold a shape in such low viscosity liquids for no more than thirty minutes.

U.S. Pat. No. 6,423,357 to Woods et al. (hereinafter “Woods”) discloses containers for holding and containing liquid food products for consumption. Woods discloses forming an edible container only from a dehydrated fruit sheet or a dehydrated vegetable sheet. The container takes the form of a cup (see Woods at FIGS. 1 to 4) or a straw (id. at FIG. 5). The method disclosed in Woods folds the sheets to create a watertight seal between the various sheets. See Woods at col. 3, lines 2 to 9, and FIG. 2. The dehydrated fruit or vegetable material can be wrapped inside or around a relative stiff bread-based material, such as a cookie or cracker, or crystallized sugar-based product. See Woods at col. 3, lines 61 to 65, and col. 4, line 9. The edible straw embodiment of Woods shown in FIG. 5 is made from spirally wound strips of waterproof food material or a seamless piece of waterproof food material that is molded or extruded in the form of a straw. See Woods at col. 4, lines 27 to 33. Woods is limited in that, to survive immersion in low viscosity liquids, such as milk, water, or juice, it requires the food container to be made from the dehydrated fruit or vegetable sheet.

U.S. Pat. No. 5,645,872 to Funahashi discloses a method and apparatus for processing food into a tubular shape. The food material used is farinaceous material obtained from konnyaku potato or other potatoes, flour, and other cereals and proteinaceous material obtained from fish, meat, gelatin, beans, eggs, and milk. See Funahashi at col. 2, lines 4 to 9. Tubular food products produced by the Funahashi device include konnyako, noodles, and fish-paste products such as chikuwa and macaroni. Nowhere does Funahashi mention creating food products able to function for imbibing liquids.

U.S. Pat. No. 4,859,165 to Hoashi discloses a food extruder that extrudes a first food in a tube-shape by passing hot water through an interior pipe 23 to solidify the inner wall of the first food to a certain degree so that it does not stick on the pipe 23. See Hoashi at col. 3, lines 11 to 20. The first food extruded is raw fish meat. The extruder simultaneously extrudes a second food on the exterior of the first food in a spiral shape. The second food is a different-colored raw fish meat.

U.S. Pat. No. 2,038,366 to Kretchmer discloses an edible licorice pipe and method of making the pipe that simulates, in certain details of construction, a conventional smoker's pipe. Accordingly, a tubular pipe 6, which is, preferably, continuously wavy, is attached by gum Arabic to a bowl portion 9. This pipe must be made from a candy material that, principally, includes sugar.

Finally, U.S. Pat. No. 575,206 to Britton discloses an artificial chewing gum straw. The gum is composed of flour, glucose, grain sugar, starch, and gum-tolu or other partially or wholly insoluble gum. As such, this straw is inedible. The paste of these ingredients is extruded through a die into the straw shape that is, later, dried. The final product can be bent when used.

A bakery sells a type of cookie straw under the trademark YOHAY®. They are wafer-type cookies that hold up in liquids due to a chocolate inner lining coating. PEPPERIDGE FARM® also manufactures a hollow wafer cookie that can only hold its shape for three minutes when immersed in 3.3° C. milk. This limitation makes it apparent why this cookie is not marketed as a straw.

Finally, a company named FISCHER & WIESER® manufactures a non-hollow cylindrical cookie product claiming to be a “cookie straw”, yet that produce cannot draw liquids therethrough. In addition, the cookie only holds its shape for three minutes when immersed in 3.3° C. milk.

All of the above embodiments fail to provide a nutrient-dense, flour-based, edible straw that is a breakfast/snack food imparting nutritional benefits while maintaining its shape during direct exposure to low viscosity liquids for more than thirty (>30) minutes, in particular, for more than sixty (>60) minutes/one hour, in cold to room temperature liquids (3.3°-18.3° C.) while still retaining its shape and the ability to function as a drinking straw and that contributes significant amount of complex carbohydrate, protein, beneficial fats, fiber, phytonutrients, vitamins, and minerals without the need of an at least water resistant coating.

Other kinds of straw assemblies include U.S. Pat. No. 4,921,713 to Fowler, which discloses a non-edible straw housing therein a flavor producing material that, when mixed with the liquid traveling through the straw, imparts a flavor to the liquid. Preferably, the material is a powdered soft drink such as those sold under the trademarks TANG® or KOOLAID®.

While U.S. Pat. No. 4,776,266 to Bradshaw, Jr. discloses an apparatus for producing cheese straws, the items disclosed as “straws” are, actually, thin elongated ribbons. See Bradshaw at col. 3, lines 48 to 55, and FIG. 1. Therefore, these food products cannot draw liquids therethrough.

Lastly, U.S. Pat. No. 2,753,267 to Rabin et al. (hereinafter “Rabin”) discloses a flavored drinking straw machine and method for making flavored drinking straws. Contrary to the name, the Rabin device actually supplements a conventional inedible drinking straw 12 made of paper or cardboards stock having a paraffin coating thereon (see Rabin at col. 4, lines 25 to 29) with a flavored insert strip 10 (see Rabin at FIGS. 4 and 7) that is frictionally held within the straw 12. See Rabin at col. 4, lines 39 to 46.

### SUMMARY OF THE INVENTION

It is accordingly an object of the invention to provide an edible straw and a method for making the straw that overcome the hereinafore-mentioned disadvantages of the heretofore-known devices and methods of this general type and that is nutrient-dense, flour-based and can withstand direct exposure to low viscosity liquids for more than thirty (>30) minutes, in particular, over sixty (>60) minutes/one hour while still retaining its shape and the ability to function as a drinking straw and that contributes significant amounts of complex carbohydrates, protein, beneficial fats, fiber, phytonutrients, vitamins, and minerals without the need for an at least water resistant coating.

The present invention, as developed by registered dietitians who are dedicated to the global nutritional health of children, provides a food that combines appealing taste with beneficial nutrition, while being truly kid-friendly. A portable, edible straw that resists milk or similar beverage and has unique marketing and configuration achieves this goal. Accordingly, the present invention encompasses an edible straw that provides significant amounts of complex carbohydrates, protein, beneficial fats, fiber, phytonutrients, vitamins, and minerals when consumed. The present invention serves as a suitable breakfast/snack option for both children and adults.

The edible straw of the present invention helps with the dilemma of poor food choices for children in the United States, and addresses the issue of unavailable nutritious food options for children in developing countries with limited nutrition. The edible straw of the present invention functions to add nutritional adequacy to overweight, healthy-weight, and underweight children. The straw product has wide appeal based on its functional configuration and delicious taste.

The present invention provides a hollow, tubular flour-based object through which beverages are imbibed. It functions like a straw when immersed in cold and room temperature beverages, such as milk, soy milk, rice milk, yogurt drinks, smoothies, shakes, juice and the like, and is completely edible. Additionally, the straw can be dunked to absorb beverages slowly and, then, consumed.

With the foregoing and other objects in view, there is provided, in accordance with the invention, a method for making an edible straw for imbibing liquids, including the steps of mixing a dry ingredient with a wet ingredient to create a dough, shaping the dough approximately as a cylinder with a cavity formed therein, and subsequently baking the dough to create an edible straw for imbibing liquids.

With the objects of the invention in view, there is also provided an edible straw for imbibing liquids, including a baked mixture of a dry ingredient with a wet ingredient having a longitudinal extent and an approximately cylindrical shape with a cavity formed therein for passing liquids therethrough over the longitudinal extent.

The straw holds up in beverages, will not speedily dissolve, and maintains its shape in room temperature liquids for at least thirty (>30) minutes, in particular, over sixty (>60) minutes/one hour. Furthermore, because the straw is nutrient rich, it can be a meal replacement or a snack, imparting balanced nutrition for both children and adults in the form of complex carbohydrates, protein, beneficial fats, fiber, phytonutrients, vitamins, and minerals.

In accordance with another mode of the invention, the baking step includes cooking the dough between approximately 275° F. and 325° F. for approximately 28 to 45 minutes.

In accordance with a further mode of the invention, the baking step is carried out by substantially evaporating moisture from the dough.

In accordance with an added mode of the invention, the dough is portioned and extruded into a substantially cylindrical shape.

In accordance with an additional mode of the invention, the dough is pierced and, then, the baking step is carried out with the pierced dough.

In accordance with yet another mode of the invention, the extruding step is carried out by creating at least one of the cylinder and the cavity utilizing a die, which can be a rod.

In accordance with yet a further mode of the invention, the cavity is created by inserting a die or rod to form the cavity and the die or rod is kept therein during baking.

In accordance with yet an added feature of the invention, the cavity is created by inserting a die to form the cavity and the die is withdrawn therefrom before baking.

In accordance with yet an additional feature of the invention, the dry ingredient is flour, a fiber source, a sugar source, a leavening agent, and/or a flavoring agent.

In accordance with again another feature of the invention, the flour is whole wheat, brown rice, gluten-free, unbleached, unbromated, all-purpose oat flour and/or gluten-free, unbleached, unbromated, all-purpose soy flour.

In accordance with again a further feature of the invention, the fiber source is guar gum, acacia, oat bran, corn bran, psyllium husks, almond meal, and/or flax seeds.

In accordance with again an added feature of the invention, the sugar is turbinado, evaporated cane sugar or juice, fructose, unsulfured molasses, date sugar, brown-rice syrup, brown sugar, and/or stevia.

In accordance with again an additional feature of the invention, the leavening agent is sodium bicarbonate and/or baking powder.

In accordance with still another feature of the invention, the flavoring agent is cocoa powder, cinnamon, spices, extracts, natural flavorings, a pure nut oil, nut butter, and/or pureed fruit.

In accordance with still a further feature of the invention, the wet ingredient is egg whites, a sugar, and/or a flavoring agent.

In accordance with still an added feature of the invention, the flour is approximately 25 to 40% by weight of the straw, in particular, approximately 34 to 38% by weight.

In accordance with still an additional feature of the invention, the fiber source is approximately 10 to 20% by weight of the straw, in particular, approximately 12 to 18% by weight.

In accordance with another feature of the invention, the sugar source is approximately 10 to 35% by weight of the straw, in particular, approximately 15 to 25% by weight.

In accordance with a further feature of the invention, the leavening agent and the flavoring agent are approximately 3 to 5% by weight of the straw, in particular, approximately 3% by weight.

In accordance with an added feature of the invention, the egg whites are approximately 15 to 30% by weight of the straw, in particular, approximately 17 to 25% by weight.

In accordance with an additional feature of the invention, there is provided a protein, a vitamin, and/or a mineral in the mixture for fortification.

In accordance with yet another feature of the invention, the cavity has a diameter of between approximately 2 and 10 mm, in particular, approximately 3 mm.

In accordance with yet a further feature of the invention, the baked mixture has an outer diameter of between approximately 3 and 30 mm, in particular, approximately 13 mm. Other features that are considered as characteristic for the invention are set forth in the appended claims.

Although the invention is illustrated and described herein as embodied in an edible straw and method for making the straw, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic, perspective view of a straw according to the invention immersed in a liquid held in a glass;

FIG. 2 is an elevational view of cylindrical dough released from an extruder prior to hollowing its center; and

FIG. 3 is a cross-sectional view of the cylindrical dough of FIG. 2 with a rod inserted therein for hollowing a center thereof.

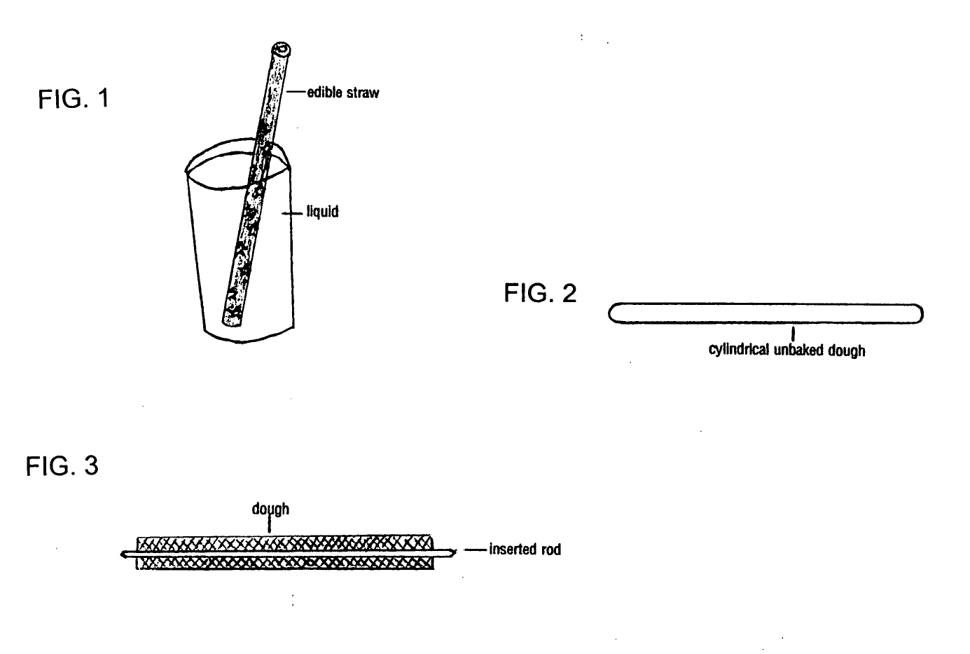

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

The method for creating the hollow, tubular, nutrient dense, flour-based drinking straw includes mixing together various ingredients and, then, conducting the baking process.

The ingredients to be mixed include both dry and wet ingredients.

The dry ingredients include the following:
flour, including, but not limited to, whole wheat, brown rice, gluten free, unbleached unbromated all purpose, oat, and/or soy; fiber sources, including, but not limited to, guar gum, acacia, oat bran, corn bran, psyllium husks, almond meal, and/or flax seeds;
leavening agents, including, but not limited to, sodium bicarbonate and/or baking powder;
flavoring agents, including, but not limited to, cocoa powder, cinnamon, spices, extracts, natural flavorings; and
certain sugars such as turbinado, evaporated cane juice, fructose, date sugar, brown sugar, and/or stevia.

The wet ingredients include the following:
egg whites;
sugars, including, but not limited to, unsulfured molasses, and/or brown-rice syrup; and
flavoring agents, including, but not limited to, pure bean and nut extracts and/or oils, nut butter, and/or pureed fruit.

Additionally, protein, vitamins, and minerals in a liquid and/or dry formula are added to enrich and fortify the product.

The ingredients for a preferred embodiment of the mixture are added according to the following percentages by weight: approximately 25 to 40% by weight of flour, in particular, between approximately 34 and 38%; approximately 10 to 20% fiber, in particular, between approximately 12 and 18%; approximately 10 to 35% sugar, in particular, between 15 and 25%; approximately 3 to 5% by weight of leavening and flavoring agents, in particular, approximately 3%; approximately 15 to 30% by weight of egg whites, in particular, between approximately 17 and 25%.

A first embodiment of the process according to the invention prepares the dough. All dry ingredients excluding sugars are, first, ground to a fine consistency and, then, double or triple sifted to aerate and create a lighter crumb.

Dry sugars are mixed with wet ingredients until dissolved. At this point, the aforementioned dry ingredients are combined with wet ingredients and the combination is mixed to a smooth, pliable consistency. The dough is portioned and rolled and/or extruded into a cylindrical shape as is shown in FIG. 2. A rod, made of, for example, 304 stainless steel bar coated with a non-stick material such as TEFLON® or SILVERSTONE® or, preferably, ULTRALON® is utilized. The rod-like structure is inserted prior to baking. Placed on baking pans, the dough is, then, baked at approximately 200° F. to 400° F. for approximately 20 to 60 minutes, in particular, approximately 275° F. to 325° F. for approximately 30 to 45 minutes. The baking process is, then, completed when the moisture has been substantially evaporated and product retains a firm consistency. The rod is removed. The product is, then, cooled at room temperature and decorated, for marketing, added flavor, and aesthetic reasons only as set forth in more detail below.

A second, alternative embodiment of the process according to the invention prepares the dough by combining the dry ingredients with the wet ingredients, as referenced above, and mixing the combination to a smooth, pliable consistency. The dough is portioned and extruded utilizing a die to create a cylindrical, hollow or solid, tubular shape. See FIG. 3. The object created is, then, baked with or without an inserted aforementioned rod-like structure until the baking process is determined to be complete, i.e., when the moisture has been evaporated and product retains a firm consistency in approximately 30 to 45 minutes, and, furthermore, at approximately 275° F. to 375° F., in particular, at approximately 275° F. to 325° F. The rod is removed if applicable, before, during, or after baking. The product is, then, cooled at room temperature and decorated for marketing, added flavor, and aesthetic reasons only.

Without departing from the attributes thereof, the final baked drinking straw may or may not be glazed, coated, or decorated for marketing, added flavor, and/or aesthetic purposes. Such decoration can include using non-artificial, food-grade, edible products such as:
flavoring oils including, but not limited to, bean, nut, and/or non-hydrogenated oils;
other natural flavors such as cinnamon, cocoa powder, spices and extracts, pure nut oils, nut butters, and/or pureed fruit;
sugars, including, but not limited to, confectioner sugar, turbinado, evaporated cane sugar, fructose, unsulfured molasses, date sugar, brown rice syrup, brown sugar, and/or stevia;
natural colors, such as vegetable powders including, but not limited to, spinach, beet, turmeric, carrot, and/or tomato;
cocoa, egg whites; and
natural shining agents, including, for example, glycerin and/or other such functional ingredients.

The edible drinking straw made according to the invention may remain in a liquid for an extended period of time, in excess of one hour, or be periodically immersed in beverages or dunked, removed, partially consumed, re-dunked, and, then, consumed.

An interior or inner diameter of the edible straw of the present invention is between approximately 2 and 10 mm (⅛ and 1/4 inch), preferably, approximately 3 mm (3/16 inch). An exterior or outer diameter of the edible straw can be as big as a consumer desires, depending on the size of the snack desired. However, a preferable configuration of the outer diameter is between approximately 3 and 30 mm (3/16 and 1 inch), preferably, approximately 13 mm (1/2 inch). Exterior ornamentation may vary based on marketing themes.

While the preferred embodiments of the invention have been illustrated and described, it will be clear that the invention is not so limited. Numerous modifications, changes, variations, substitutions, and equivalents will occur to those skilled in the art without departing from the spirit and scope of the present invention as defined by the appended claims.

1. A method for making a nutritious edible straw for imbibing liquids, which comprises:
mixing a dry ingredient with a wet ingredient to create a dough;
shaping the dough approximately as a cylinder with a cavity formed therein; and
subsequently baking the dough to create an edible straw for imbibing liquids.

2. The method according to claim 1, which further comprises selecting the dry ingredient from at least one of the group consisting of flour, a fiber source, a sugar source, a leavening agent, and a flavoring agent.

3. The method according to claim 2, which further comprises selecting the flour from at least one of the group consisting of whole wheat, brown rice, gluten-free, unbleached, unbromated, all-purpose oat flour and gluten-free, unbleached, unbromated, all-purpose soy flour.

4. The method according to claim 2, which further comprises selecting the fiber source from at least one of the group consisting of guar gum, acacia, oat bran, corn bran, psyllium husks, almond meal, and flax seeds.

5. The method according to claim 2, which further comprises selecting the sugar source from at least one of the group consisting of turbinado, evaporated cane juice, fructose, date sugar, brown sugar, and stevia.

6. The method according to claim 2, which further comprises selecting the leavening agent from at least one of the group consisting of sodium bicarbonate and baking powder.

7. The method according to claim 2, which further comprises selecting the flavoring agent from at least one of the group consisting of cocoa powder, cinnamon, spices, extracts, and natural flavorings.

8. The method according to claim 1, which further comprises selecting the wet ingredient from at least one of the group consisting of egg whites, a sugar, and a flavoring agent.

9. The method according to claim 8, which further comprises selecting the sugar from at least one of the group consisting of unsulfured molasses and brown-rice syrup.

10. The method according to claim 8, which further comprises selecting the flavoring agent from at least one of the group consisting of extracts, pure nut oils, nut butters, and pureed fruit.

11. The method according to claim 2, which further comprises portioning the flour to be approximately 25 to 40% by weight of the straw.

12. The method according to claim 11, which further comprises portioning the flour to be approximately 34 to 38% by weight of the straw.

13. The method according to claim 2, which further comprises portioning the fiber source to be approximately 10 to 20% by weight of the straw.

14. The method according to claim 13, which further comprises portioning the fiber source to be approximately 12 to 18% by weight of the straw.

15. The method according to claim 2, which further comprises portioning the sugar source to be approximately 10 to 35% by weight of the straw.

16. The method according to claim 15, which further comprises portioning the sugar source to be approximately 15 to 25% by weight of the straw.

17. The method according to claim 2, which further comprises portioning the leavening agent and the flavoring agent to be approximately 3 to 5% by weight of the straw.

18. The method according to claim 17, which further comprises portioning the leavening agent and the flavoring agent to be approximately 3% by weight of the straw.

19. The method according to claim 8, which further comprises portioning the egg whites to be approximately 15 to 30% by weight of the straw.

20. The method according to claim 19, which further comprises portioning the egg whites to be approximately 17 to 25% by weight of the straw.

21. The method according to claim 1, which further comprises adding at least one of the group consisting of a protein, a vitamin, and a mineral to the dough for fortification.

22. The method according to claim 1, wherein the baking step includes cooking the dough between approximately 275° F. and 325° F. for approximately 30 to 45 minutes.

23. The method according to claim 22, which further comprises carrying out the baking step by substantially evaporating moisture from the dough.

24. The method according to claim 1, which further comprises portioning and extruding the dough into a substantially cylindrical shape.

25. The method according to claim 24, which further comprises piercing the dough and then carrying out the baking step with the pierced dough.

26. The method according to claim 24, which further comprises carrying out the extruding step by creating at least one of the cylinder and the cavity utilizing a die.

27. The method according to claim 1, which further comprises creating the cavity by inserting a die to form the cavity and keeping the die therein during baking.

28. The method according to claim 1, which further comprises creating the cavity by inserting a die to form the cavity and withdrawing the die therefrom one of before, during, and after baking.

29. The method according to claim 1, which further comprises carrying out the shaping step by forming the cavity with a diameter of between approximately 2 and 10 mm.

30. The method according to claim 1, which further comprises carrying out the shaping step by forming the cavity with a diameter of approximately 3 mm.

31. The method according to claim 1, which further comprises carrying out the shaping step by forming the straw with an outer diameter of between approximately 3 and 30 mm.

32. The method according to claim 1, which further comprises carrying out the shaping step by forming the straw with an outer diameter of approximately 13 mm.

33. The method according to claim 1, which further comprises decorating the edible straw.

34. An edible straw for imbibing liquids, comprising:
a baked mixture of a dry ingredient with a wet ingredient having a longitudinal extent and an approximately cylindrical shape with a cavity formed therein for passing liquids therethrough over said longitudinal extent.

35. The straw according to claim 34, wherein said baked mixture substantially retains its shape in a liquid for at least 30 minutes.

36. The straw according to claim 34, wherein said dry ingredient is selected from at least one of the group consisting of flour, a fiber source, a sugar source, a leavening agent, and a flavoring agent.

37. The straw according to claim 36, wherein said flour is selected from at least one of the group consisting of whole wheat, brown rice, gluten-free, unbleached, unbromated, all-purpose oat flour and gluten-free, unbleached, unbromated, all-purpose soy flour.

38. The straw according to claim 36, wherein said fiber source is selected from at least one of the group consisting of guar gum, acacia, oat bran, corn bran, psyllium husks, almond meal, and flax seeds.

39. The method according to claim 36, wherein said sugar source is selected from at least one of the group consisting of turbinado, evaporated cane juice, fructose, date sugar, brown sugar, and stevia.

40. The straw according to claim 36, wherein said leavening agent is selected from at least one of the group consisting of sodium bicarbonate and baking powder.

41. The straw according to claim 36, wherein said flavoring agent is selected from at least one of the group consisting of cocoa powder, cinnamon, spices, extracts, natural flavorings, pure nut oils, nut butters, and pureed fruit.

42. The straw according to claim 34, wherein said wet ingredient is selected from at least one of the group consisting of egg whites, a sugar, and a flavoring agent.

43. The straw according to claim 42, wherein said sugar is selected from at least one of the group consisting of unsulfured molasses and brown-rice syrup.

44. The straw according to claim 42, wherein said flavoring agent is selected from at least one of the group consisting of extracts, pure nut oils, nut butters, and pureed fruit.

45. The straw according to claim 36, wherein said flour is approximately 25 to 40% by weight of the straw.

46. The straw according to claim 36, wherein said flour is approximately 34 to 38% by weight of the straw.

47. The straw according to claim 36, wherein said fiber source is approximately 10 to 20% by weight of the straw.

48. The straw according to claim 36, wherein said fiber source is approximately 12 to 18% by weight of the straw.

49. The straw according to claim 36, wherein said sugar source is approximately 10 to 35% by weight of the straw.

50. The straw according to claim 36, wherein said sugar source is approximately 15 to 25% by weight of the straw.

51. The straw according to claim 36, wherein said leavening agent and said flavoring agent are approximately 3 to 5% by weight of the straw.

52. The straw according to claim 36, wherein said leavening agent and said flavoring agent are approximately 3% by weight of the straw.

53. The straw according to claim 42, wherein said egg whites re approximately 15 to 30% by weight of the straw.

54. The straw according to claim 42, wherein said egg whites are approximately 17 to 25% by weight of the straw.

55. The straw according to claim 34, further comprising at least one of a protein, a vitamin, and a mineral in said mixture.

56. The straw according to claim 34, further comprising a decoration.

57. The method according to claim 34, wherein said cavity has a diameter of between approximately 2 and 10 mm.

58. The method according to claim 34, wherein said cavity has a diameter of approximately 3 mm.

59. The method according to claim 34, wherein said baked mixture has an outer diameter of between approximately 3 and 30 mm.

60. The method according to claim 34, wherein said baked mixture has an outer diameter of approximately 13 mm.

61. An edible straw for imbibing liquids, comprising:
a nutritious baked mixture of a dry ingredient with a wet ingredient having a longitudinal extent and an approximately cylindrical shape with a cavity formed therein for passing liquids therethrough over said longitudinal extent, said baked mixture substantially retaining its shape in a liquid for at least 30 minutes.
